(19) United States
(12) Patent Application Publication
(10) Pub. No.: US 2024/0371387 A1
(43) Pub. Date: Nov. 7, 2024

(54) AREA SOUND PICKUP METHOD AND SYSTEM OF SMALL MICROPHONE ARRAY DEVICE

(71) Applicant: SUZHOU AUDITORYWORKS CO., LTD., Suzhou (CN)

(72) Inventors: Zhiqiang HU, Suzhou (CN); Xin XIN, Suzhou (CN)

(21) Appl. No.: 18/249,254

(22) PCT Filed: Jan. 26, 2022
(86) PCT No.: PCT/CN2022/073941

§ 371 Date: Apr. 16, 2023

(30) Foreign Application Priority Data
Dec. 15, 2021 (CN) 202111537638.5

(51) Int. Cl. G10L 21/0232; G10L 21/0216; G10L 25/18; G10L 25/21; G10L 25/30; G10L 25/84; H04R 5/027; H04S 3/00

(52) U.S. Cl. CPC G10L 21/0232; G10L 25/18; G10L 25/21; G10L 25/30; G10L 25/84; H04R 5/027; H04S 3/008; G10L 2021/02166; H04R 2410/01; H04S 2400/15

(57) ABSTRACT

The present disclosure discloses an area sound pickup method, which includes: receiving a multi-channel voice input signal from the small microphone array device, and performing a non-linear beamforming; performing an area synthesis on a multi-beam data set by using an area synthesis algorithm; processing an area beam signal by using a voice activation detection algorithm based on a neural network; detecting the multi-beam data set and the area beam signal; and enhancing the sound pickup area voice signal, suppressing the to-be-shielded signal, and not processing the noise signals.

### CROSS-REFERENCE TO RELATED APPLICATION

This application claims priority to Chinese Patent Application No. 202111537638.5 filed on Dec. 15, 2021 in the Chinese Patent Office and entitled “Area Sound Pickup Method and System of Small Microphone Array Device”, the entire contents of which are incorporated herein by reference.

### TECHNICAL FIELD

The present disclose relates to an area sound pickup field, and in particular, to an area sound pickup method and a system of small microphone array device.

### BACKGROUND

In a remote voice conference scenario, unwanted interference sounds in the scenario are generally shielded to help improve the quality of the conference to facilitate a remote communication. This function is implemented generally by selectively shielding voices in respectively directions in the environment, by configuring a spatial filter in combination with a highly directional large-sized microphone array and a beamforming method.

However, in a scenario of a personal remote teleconference or a small conference room between two to three parties, in consideration of portability and economy, a large microphone array is not generally selected, but a camera, a portable microphone, or the like for a small web conference is selected. These small conference devices typically include a sound pickup array consist of 2-6 microphones. Due to the aperture size of the array, current beamforming methods are insufficient to achieve an area shielding effect. Under the premise of a same microphone pitch, the more the number of the microphones (that is, the larger the array size), the better the directivity formed, thereby more accurate pickup performance in the main direction and more suppression in other directions.

### Technical Problems

In addition to the current beamforming methods, it is also possible to distinguish different sound sources by using azimuth estimation information or subspace decomposition information. However, these methods are all limited by an aperture, a computing power of a device, and the like, of the microphone array, and cannot exert their actual effects. Therefore, for a small microphone conference device with a limited computing power, it is an urgent problem to achieve a more accurate spatial shield effect.

### Technical Solutions

A technical problem to be solved by the present disclosure is to provide an area pickup method for a small microphone array device capable of picking up sound of a specified area without distortion and shielding the interference outside the area.

In order to solve the above problem, the present disclosure provides an area sound pickup method for a small microphone array device, wherein the area pickup method for a small microphone array device includes the steps of:
S1. receiving a multi-channel voice input signal from the small microphone array device, dividing an area where the small microphone array device is located into a sound pickup area and a shield area, subdividing the sound pickup area and the shield area respectively into a plurality of angles, performing a non-linear beamforming on beams in each angle, to obtain a weight gain corresponding to each frequency point data in the sound pickup area and a weight gain corresponding to each frequency point data in the shield area, and multiplying each frequency point data respectively by a corresponding weight gain to obtain a multi-beam data set;
S2. performing an area synthesis on the multi-beam data set by using an area synthesis algorithm, synthesizing a plurality of beams corresponding to each frequency point data to obtain a final weight gain for each frequency point, and multiplying each frequency point data by the corresponding final weight gain, to obtain a synthesized area beam signal;
S3. processing the area beam signal by using a voice activation detection algorithm based on a neural network, to obtain a label for the voice signal or the noise signal;
S4. performing an energy gain detection and a spectrum feature detection on the multi-beam data set and the area beam signal to obtain a label for a sound pickup area voice signal or a shield area voice signal label, wherein the shield area voice signal includes a noise signal and a to-be-shielded signal; and
S5. according to the labels, enhancing the sound pickup area voice signal, suppressing the to-be-shielded signal, and not processing the noise signals.

As a further improvement of the present disclosure, the performing the non-linear beamforming on the beams in each angle to obtain the weight gain corresponding to each frequency point data in the sound pickup area and the weight gain corresponding to each frequency point data in the shield area includes: for a plurality of microphone arrays of a microphone device, a transfer function h(θ) for a signal in a specified azimuth angle θ to reach respective microphones is shown below:

$$h ( θ ) = {\frac{1}{\sqrt{M}} [ 1 , {e}^{- jkdsin ( θ )} , … , {e}^{- jMkdsin ( θ )} ]}^{T}$$

wherein k=2πƒ/c; ƒ represents a frequency, c represents a sound velocity, d represents a microphone pitch, and M represents the number of microphones;
an observed signal vector for each microphone at each frequency point is obtained as following:

$${x}_{m} ( k , θ ) = {h}_{s} ( k , θ ) S ( k , θ ) + {h}_{i} ( k , θ ) {S}_{i} ( k , θ ) + n ( k , θ )$$

wherein S(k,θ) represents a signal component expected to be obtained, hₛ represents a transfer function of the signal component expected to be obtained; Sᵢ(k, θ) represents an interference signal component, hᵢ is a transfer function of the interference signal component; η(k,θ) represents a noise component; and 0≤m≤M−1;
an observed signal vector for all microphones at each frequency point is obtained as following:

$$X ( k , θ ) = {[ {x}_{1} ( k , θ ) , {x}_{2} ( k , θ ) , … , {x}_{M} ( k , θ ) ]}^{T}$$

on the basis of the current beamforming output, an adaptive gain value g is further multiplied, and the result is expressed as:

Ŷ=gY, i.e. Ŷ=g·w^{H}X
wherein Y=w^{H}X, w represents a weight, H represents a transpose conjugate;
the weight gain for each frequency point data is expressed as:

$${ℊ}^{*} = {argmin}_{ℊ} E [ {\vert {H}^{} {h}_{s} S - ℊ {H}^{} X \vert}^{2} ]$$

wherein E[·] represents a mathematical expectation, S represents an expected actual signal, and the internal polynomial is expanded to obtain:

$$\begin{matrix}{ℊ}^{*} = {argmin}_{ℊ} E [ \vert {H}^{} {\vert Y \vert}^{2} - ℊ {\vert {H}^{} {h}_{s} \vert}^{2} {\vert S \vert}^{2} \vert ] \\ = {argmin}_{ℊ} ℊ - \frac{E [ {\vert {H}^{} {h}_{s} \vert}^{2} {\vert S \vert}^{2} ]}{E [ {\vert S \vert}^{2} ]}\end{matrix}$$

considering a minimization condition, it is omitted as following:

$${ℊ}^{*} = \frac{E [ {\vert {H}^{} {h}_{s} \vert}^{2} {\vert S \vert}^{2} ]}{E [ {\vert S \vert}^{2} ]} .$$

As a further improvement of the present disclosure, in step S4, an energy gain is detected by using a full band energy difference before and after each frame processing and a specific quantile gain value under a full band.

As a further improvement of the present disclosure, a spectrum feature is detected by using spectrum difference values before and after each frame processing.

As a further development of the present disclosure, in step S4, a jitter of values is eliminated by a feature accumulation and a feature smoothing.

As a further improvement of the present disclosure, the receiving the multi-channel voice input signal from the small microphone array device includes: the multi-channel voice input signal is converted into a frequency domain signal from a time domain signal through a multi-channel voice-framing and a short-time Fourier transform.

As a further improvement of the present disclosure, after obtaining the synthesized area beam signal, the area pickup method further includes: according to a probability density synthesis principle, obtaining the final weight gain of the synthesized area beam signal for each frequency point.

As a further improvement of the present disclosure, the processing the area beam signal by using the voice activation detection algorithm based on the neural network, to obtain the label for the voice signal or the noise signal includes: performing a convolution on the area beam signal in a time-frequency axis; calculating a convolved output by using a PRelu activation function; connecting a calculated output to a maximum pooling layer for pooling; sending a pooled output to a normalization layer for a normalization process; sending a normalized output to an LSTM layer for detection; and sending a detected output to a DNN fully connected layer for classification, and outputting a final frame prediction result through a Sigmoid function, thereby obtaining the label for the voice signal or the noise signal.

As a further improvement of the present disclosure, the enhancing the sound pickup area voice signal, suppressing the to-be-shielded signal, and not processing the noise signals according to the labels includes: keeping amplitudes of the noise signals and an amplitude of a suppressed shielded signal at a similar level, and meanwhile enhancing the voice signal in the sound pickup area.

In order to solve the above problem, the present disclosure also provides an area sound pickup system of a small microphone array device, including the following modules:
a non-linear multi-beamforming module configured to receive a multi-channel voice input signal from the small microphone array device, divide an area where the small microphone array device is located into a sound pickup area and a shield area, subdivide the sound pickup area and the shield area respectively into a plurality of angles, perform a non-linear beamforming on beams in each angle to obtain a weight gain corresponding to each frequency point data in the sound pickup area and a weight gain corresponding to each frequency point data in the shield area, and multiply each frequency point data respectively by a corresponding weight gain to obtain a multi-beam data set;
a sound pickup area synthesis module configured to an area synthesis on the multi-beam data set by using an area synthesis algorithm, synthesize a plurality of beams corresponding to each frequency point data to obtain a final weight gain for each frequency point, and multiply each frequency point data by the corresponding final weight gain, to obtain a synthesized area beam signal;
a voice detection module configured to process the area beam signal by using a voice activation detection algorithm based on a neural network to obtain a label for the voice signal or the noise signal;
a post-processing module configured to perform an energy gain detection and a spectrum feature detection on the multi-beam data set and the area beam signal to obtain a label for a sound pickup area voice signal or a shield area voice signal, wherein the shield area voice signal includes a noise signal and a to-be-shielded signal; and
a sound pickup area voice enhancement module configured to enhance the sound pickup area voice signal, suppress the to-be-shielded signal, and not process the noise signals, according to the labels.

As a further improvement of the present disclosure, the performing the non-linear beamforming on the beams in each angle, to obtain the weight gain corresponding to each frequency point data in the sound pickup area and the weight gain corresponding to each frequency point data in the shield area includes:
for a plurality of microphone arrays of a microphone device, a transfer function h(θ) for a signal in a specified azimuth angle θ to reach respective microphones is shown below:

$$h ( θ ) = {\frac{1}{\sqrt{M}} [ 1 , {e}^{- jkdsin ( θ )} , … , {e}^{- jMkdsin ( θ )} ]}^{T}$$

wherein k=2πƒ/c, ƒ represents a frequency, c represents a sound velocity, d represents a microphone pitch, and M represents the number of microphones;
an observed signal vector for each microphone at each frequency point is obtained as following

$${x}_{m} ( k , θ ) = {h}_{s} ( k , θ ) S ( k , θ ) + {h}_{i} ( k , θ ) {S}_{i} ( k , θ ) + n ( k , θ )$$

wherein S(k,θ) represents a signal component expected to be obtained, hₛ represents a transfer function of the signal component expected to be obtained; Sᵢ(k,θ) represents an interference signal component, hᵢ is a transfer function of the interference signal component; η(k,θ) represents a noise component; and 0≤m≤M−1;
an observed signal vector for all microphones at each frequency point is obtained as following:

X(k,θ)=[x₁(k,θ),x₂(k,θ), . . . ,x_{M}(k,θ)]^{T}
on the basis of the current beamforming output, an adaptive gain value g is further multiplied, and the result is expressed as:

Ŷ=gY, i.e. Ŷ=g·w^{H}X
wherein Y=w^{H}X, w represents a weight, H represents a transpose conjugate;
the weight gain for each frequency point data is expressed as:

$${ℊ}^{*} = {argmin}_{ℊ} E [ {\vert {H}^{} {h}_{s} S - ℊ {H}^{} X \vert}^{2} ]$$

wherein E[·] represents a mathematical expectation, S represents an expected actual signal, and the internal polynomial is expanded to obtain:

$$\begin{matrix}{ℊ}^{*} = {argmin}_{ℊ} E [ \vert {H}^{} {\vert Y \vert}^{2} - ℊ {\vert {H}^{} {h}_{s} \vert}^{2} {\vert S \vert}^{2} \vert ] \\ = {argmin}_{ℊ} ℊ - \frac{E [ {\vert {H}^{} {h}_{s} \vert}^{2} {\vert S \vert}^{2} ]}{E [ {\vert S \vert}^{2} ]}\end{matrix}$$

considering a minimization condition, it is omitted as following:

$${ℊ}^{*} = \frac{E [ {\vert {H}^{} {h}_{s} \vert}^{2} {\vert S \vert}^{2} ]}{E [ {\vert S \vert}^{2} ]} .$$

As a further improvement of the present disclosure, the post-processing module includes an energy gain detection module that detects an energy gain by using a full band energy difference before and after each frame processing and a specific quantile gain value under a full band.

As a further improvement of the present disclosure, the post-processing module includes a spectrum feature detection module, and the spectrum feature detection detects a spectrum feature are detected by using spectrum difference values before and after each frame processing.

As a further improvement of the present disclosure, the post-processing module includes a feature accumulation module and a feature smoothing module through which a jitter of values is eliminated.

As a further improvement of the present disclosure, the non-linear multi-beamforming module is further configured to convert the multi-channel voice input signal into a frequency domain signal from a time domain signal through a multi-channel voice-framing and a short-time Fourier transform.

As a further improvement of the present disclosure, the sound pickup area synthesis module is further configured to obtain the final weight gain of the synthesized area beam signal for each frequency point, according to a probability density synthesis principle.

As a further development of the present disclosure, the voice detection module is further configured to: perform a convolution on the area beam signal in a time-frequency axis; calculate a convolved output by using a PRelu activation function; connect a calculated output to a maximum pooling layer for pooling; send a pooled output to a normalization layer for a normalization process; send a normalized output to an LSTM layer for detection; and send a detected output to a DNN fully connected layer for classification, and output a final frame prediction result through a Sigmoid function, thereby obtaining the label for the voice signal or the noise signal.

As a further improvement of the present disclosure, the sound pickup area voice enhancement module is configured to keep amplitudes of the noise signals and an amplitude of a suppressed shielded signal at a similar level, and meanwhile enhance the voice signal in the sound pickup area.

In order to solve the above problem, the present disclosure further provides a small microphone array device including microphone devices and a processor, wherein the processor is configured to:
S1. receiving a multi-channel voice input signal from the small microphone array device, dividing an area where the small microphone array device is located into a sound pickup area and a shield area, subdividing the sound pickup area and the shield area respectively into a plurality of angles, performing a non-linear beamforming on beams in each angle, to obtain a weight gain corresponding to each frequency point data in the sound pickup area and a weight gain corresponding to each frequency point data in the shield area, and multiplying each frequency point data respectively by a corresponding weight gain to obtain a multi-beam data set;
S2. performing an area synthesis on the multi-beam data set by using an area synthesis algorithm, synthesizing a plurality of beams corresponding to each frequency point data to obtain a final weight gain for each frequency point, and multiplying each frequency point data by the corresponding final weight gain, to obtain a synthesized area beam signal;
S3. processing the area beam signal by using a voice activation detection algorithm based on a neural network, to obtain a label for the voice signal or the noise signal;
S4. performing an energy gain detection and a spectrum feature detection on the multi-beam data set and the area beam signal to obtain a label for a sound pickup area voice signal or a shield area voice signal, wherein the shield area voice signal includes a noise signal and a to-be-shielded signal; and
S5. according to the labels, enhancing the sound pickup area voice signal, suppressing the to-be-shielded signal, and not processing the noise signals.

As a further development of the invention, in step S1, the processor is further configured for:
for a plurality of microphone arrays of a microphone device, a transfer function h(θ) for a signal in a specified azimuth angle θ to reach respective microphones is shown below:

$$h ( θ ) = {\frac{1}{\sqrt{M}} [ 1 , {e}^{- jkdsin ( θ )} , … , {e}^{- jMkdsin ( θ )} ]}^{T}$$

wherein k=2πƒ/c, ƒ represents a frequency, c represents a sound velocity, d represents a microphone pitch, and M represents the number of microphones;
an observed signal vector for each microphone at each frequency point is obtained as following:

$${x}_{m} ( k , θ ) = {h}_{s} ( k , θ ) S ( k , θ ) + {h}_{i} ( k , θ ) {S}_{i} ( k , θ ) + n ( k , θ )$$

wherein S(k,θ) represents a signal component expected to be obtained, hₛ represents a transfer function of the signal component expected to be obtained; Sᵢ(k,θ) represents an interference signal component, hᵢ is a transfer function of the interference signal component; η(k,θ) represents a noise component; and 0≤m≤M−1;
an observed signal vector for all microphones at each frequency point is obtained as following:

X(k,θ)=[x₁(k,θ),x₂(k,θ), . . . ,x_{M}(k,θ)]^{T}
on the basis of the current beamforming output, an adaptive gain value g is further multiplied, and the result is expressed as:

Ŷ=gY, i.e. Ŷ=g·w^{H}X
wherein Y=w^{H}X, w represents a weight, H represents a transpose conjugate;
the weight gain for each frequency point data is expressed as:

$${ℊ}^{*} = {argmin}_{ℊ} E [ {\vert {H}^{} {h}_{s} S - ℊ {H}^{} X \vert}^{2} ]$$

wherein E[·] represents a mathematical expectation, S represents an expected actual signal, and the internal polynomial is expanded to obtain:

$$\begin{matrix}{ℊ}^{*} = {argmin}_{ℊ} E [ \vert {H}^{} {\vert Y \vert}^{2} - ℊ {\vert {H}^{} {h}_{s} \vert}^{2} {\vert S \vert}^{2} \vert ] \\ = {argmin}_{ℊ} ℊ - \frac{E [ {\vert {H}^{} {h}_{s} \vert}^{2} {\vert S \vert}^{2} ]}{E [ {\vert S \vert}^{2} ]}\end{matrix}$$

considering a minimization condition, it is omitted as following:

$${ℊ}^{*} = \frac{E [ {\vert {H}^{} {h}_{s} \vert}^{2} {\vert S \vert}^{2} ]}{E [ {\vert S \vert}^{2} ]}$$

The foregoing description is merely an overview of a technical solution of the present disclosure, and may be implemented in accordance with the content of the specification in order to be able to understand technical means of the present disclosure more clearly. In order to make the above and other objects, features and advantages of the present disclosure more clearly understandable, preferred embodiments are hereby set forth below, and detailed description thereof is provided below in conjunction with the accompanying drawings.

### BENEFICIAL EFFECTS

According to an area sound pickup method and a system of the small microphone array device in the present disclosure, a high-directionality area sound pickup effect may be realized, so that the small microphone array device can pick up the sound of a specified interested area without distortion and shield an interference sound outside the area. Thus, the quality of a remote conference may be improved, and a site cost may be saved.

According to the method and the system of the present disclosure, the voice output by the small microphone array device may have obvious intra-area and extra-area comparison, and may ensure better auditory continuity.

### BRIEF DESCRIPTION OF THE DRAWINGS

In order to explain more clearly technical solutions in embodiments of the present disclose, the drawings required for describing the embodiments will be briefly described below.

FIG. 1 is a flowchart of an area sound pickup method for a small and medium microphone array device according to a preferred embodiment of the present disclose;

FIG. 2 is a schematic view of an area sound pickup system of a small and medium microphone array device according to a preferred embodiment of the present disclose;

FIG. 3 is a schematic view of a non-linear multi-beamforming module in an area sound pickup system of a small and medium microphone array device according to a preferred embodiment of the present disclose; and

FIG. 4 is a schematic view of a post-processing module in an area sound pickup system of a small and medium microphone array device according to a preferred embodiment of the present disclose.

### DESCRIPTION OF SPECIFIC EMBODIMENTS OF THE INVENTION

The present disclose is further described below in conjunction with the accompanying drawings and specific embodiments to enable those skilled in the art to better understand and practice the present disclose, but the presented examples are not intended to limit the invention.

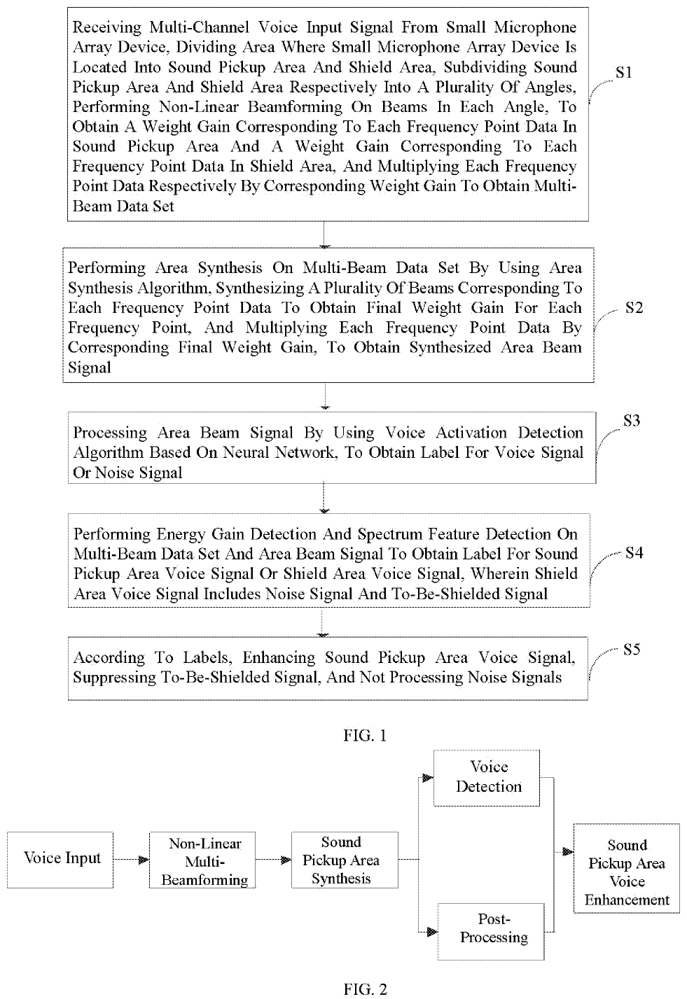

As shown in FIG. 1, an area sound pickup method for a small microphone array device according to a preferred embodiment of the present disclose includes the following steps:

Step S1: receiving a multi-channel voice input signal from the small microphone array device, dividing an area where the small microphone array device is located into a sound pickup area(s) and a shield area(s), subdividing the sound pickup area(s) and the shield area(s) respectively into a plurality of angles, performing a non-linear beamforming on beams in each angle, to obtain a weight gain(s) corresponding to each frequency point data in the sound pickup area(s) and a weight gain(s) corresponding to each frequency point data in the shield area(s), and multiplying each frequency point data respectively by a corresponding weight gain(s) to obtain a multi-beam data set(s).

Specifically, in Step S1, first, the multi-channel voice input signal is converted into a frequency domain signal from a time domain signal through a multi-channel voice-framing and a short-time Fourier transform (STFT).

Although the space is continuous, since the space cannot be subdivided infinitesimally due to a beam directivity, the space is only needed to be divided into a plurality of specified angles, that is, a plurality of discrete small areas, in the algorithm. For respective discrete small areas (pickup or shield areas), the non-linear beamforming is repeated multiple times.

Specifically, the performing the non-linear beamforming on the beams in each angle, to obtain the weight gain(s) corresponding to each frequency point data in the sound pickup area(s) and the weight gain(s) corresponding to each frequency point data in the shield area(s) includes:

For a plurality of microphone arrays of a microphone device, a transfer function h(θ) for a signal in a specified azimuth angle θ to reach respective microphones is shown below.

$$h ( θ ) = {\frac{1}{\sqrt{M}} [ 1 , {e}^{- jkdsin ( θ )} , … , {e}^{- jMkdsin ( θ )} ]}^{T}$$

Wherein k=2πƒ/c, ƒ represents a frequency, c represents a sound velocity, d represents a microphone pitch, and M represents the number of microphones.

An observed signal vector for each microphone at each frequency point is obtained as following:

$${x}_{m} ( k , θ ) = {h}_{s} ( k , θ ) S ( k , θ ) + {h}_{i} ( k , θ ) {S}_{i} ( k , θ ) + n ( k , θ )$$

Wherein S(k,θ) represents a signal component expected to be obtained, hₛ represents a transfer function of the signal component expected to be obtained; Sᵢ(k,θ) represents an interference signal component, hᵢ is a transfer function of the interference signal component; η(k, θ) represents a noise component; and 0≤m≤M−1.

An observed signal vector for all microphones at each frequency point is obtained as following:

X(k,θ)=[x₁(k,θ),x₂(k,θ), . . . ,x_{M}(k,θ)]^{T}

A current linear beam output signal Y is as follows:

Y=w^{H}X

That is, w represents a weight, H represents a transpose conjugate. A constant weight w may be applied to each frame signal. Thus, the current linear beam output signal Y cannot be applied to time-varying environmental changes.

Step S1 is intended to obtain a weight that varies with signal features, such that a signal of interest and a signal to be suppressed may be separated at each frequency point. That is, a frequency point at which the signal of interest has a larger proportion is not attenuated or less attenuated, and the interference signal component is suppressed, to preliminarily screen signals in the sound pickup area(s).

On the basis of the current beamforming output, an adaptive gain value g is further multiplied. The result is expressed as:

Ŷ=gY, i.e. Ŷ=g·w^{H}X

Wherein Y=w^{H}X, w represents a weight, H represents a transpose conjugate.

In order to obtain this gain, an equation may be designed below such that the error between a processed output signal and an actual noise-free signal component to be separated is smaller. The weight gain for each frequency point data is expressed as:

$${ℊ}^{*} = {argmin}_{ℊ} E [ {\vert {H}^{} {h}_{s} S - ℊ {H}^{} X \vert}^{2} ]$$

Wherein E[·] represents a mathematical expectation, S represents an expected actual signal. The internal polynomial is expanded to obtain:

$$\begin{matrix}{ℊ}^{*} = {argmin}_{ℊ} E [ \vert {H}^{} {\vert Y \vert}^{2} - ℊ {\vert {H}^{} {h}_{s} \vert}^{2} {\vert S \vert}^{2} \vert ] \\ = {argmin}_{ℊ} ℊ - \frac{E [ {\vert {H}^{} {h}_{s} \vert}^{2} {\vert S \vert}^{2} ]}{E [ {\vert S \vert}^{2} ]}\end{matrix}$$

Considering a minimization condition, it is omitted as following:

$${ℊ}^{*} = \frac{E [ {\vert {H}^{} {h}_{s} \vert}^{2} {\vert S \vert}^{2} ]}{E [ {\vert S \vert}^{2} ]}$$

The non-linear beamforming algorithm described above is repeatedly performed for each angle, to obtain a preliminary area screening signal, i.e., the above multi-beam data set.

Step S2: performing an area synthesis on the multi-beam data set by using an area synthesis algorithm, synthesizing a plurality of beams corresponding to each frequency point data to obtain a final weight gain for each frequency point, and multiplying each frequency point data by the corresponding final weight gain, to obtain a synthesized area beam signal.

Since the actual problem to be solved is to obtain an area sound pickup or suppression effect for a whole area, a non-linear beam result obtained in step S1 is that the sound pickup area(s) is too narrow to meet the actual use requirement. Therefore, it is necessary to synthesize narrow beams in a plurality of sound pickup areas into an area beam result.

Specifically, according to a probability density synthesis principle, a gain of the synthesized area beam for each frequency point is obtained.

Step S3: processing the area beam signal by using a voice activation detection algorithm based on a neural network, to obtain a label for the voice signal or the noise signal.

The voice activation detection (VAD) algorithm is an important part of a voice front-end algorithm, and it tended to detect a voice from an audio signal obtained by the microphones in order for the voice to be processed by subsequent algorithms. In real-time conference scenarios, an accuracy of the VAD algorithm has a significant impact on subsequent algorithms and the final sound quality. A modeling is mainly based on the characteristics of the voice in the current VAD method, which has higher requirements for an external environment and a signal-to-noise ratio of the voice, and cannot handle some transient noise such as knock sound, keyboard sound, or the like. Recently, a VAD method based on a neural network, where human sound is detected under a complex scene by a powerful data fitting capability of the neural network, is more and more popular, and an effect of this VAD method is generally superior to a current algorithm.

Specifically, first, a forty-dimensional feature via a feature extraction is sent to a first layer, i.e., a convolution layer, of a model. The convolution layer is composed of sixteen convolution nuclei, each of which has a dimension of 1×8, and the convolution nuclei performs a convolution in a time-frequency axis, in order to learn a correlation information between frequency sub-bands. Then a calculation is performed by using a PRelu activation function, followed by a maximum pooling layer with a pooling dimension of 1×3. Subsequently, a pooled output is sent to a normalization layer, which normalizes each feature map, thereby effectively reducing an occurrence of misjudgment caused by a change in a voice amplitude. Then, an output is sent to an LSTM layer, and the LSTM can effectively learn the correlation information between frames, which greatly improves the voice detection accuracy. Finally, it is sent to a DNN fully connected layer for classification, and a final frame prediction result is output through a Sigmoid function. A label for the voice signal or the noise signal is obtained.

Step S4: performing an energy gain detection and a spectrum feature detection on the multi-beam data set and the area beam signal, to obtain a label for a sound pickup area voice signal or a shield area voice signal, wherein the shield area voice signal includes a noise signal and a to-be-shielded signal.

Preferably, an energy gain is detected by using a full band energy difference before and after each frame processing and a specific quantile gain value under a full band. A spectrum feature is detected by using spectrum difference values before and after each frame processing. A jitter of values is eliminated by a feature accumulation and a feature smoothing.

For each detection result, a threshold is set by analyzing for a large amount of off-line data and the three characteristics are synthesized by non-uniform weighting. For stability of the result, the jitter of values is eliminated by multi-frame accumulation and smoothing. Finally, classification into the pickup area and the shield area may be performed on each frame signal.

Step S5: according to the labels, enhancing the sound pickup area voice signal, suppressing the to-be-shielded signal, and not processing the noise signals.

In order to improve the audio continuity, it is preferable that voice frames determined as a background noise are not processed or the suppression amount is reduced for the voice frames determined as a background noise. A noise amplitude and a suppressed shielded voice are kept at a similar level, and meanwhile, a voice in the sound pickup area(s) is enhanced.

After the above-described processing, an output voice may have obvious intra-region and out-of-region contrast, and a better auditory continuity may be ensured.

### EMBODIMENT 2

As shown in FIG. 2, the present embodiment discloses an area sound pickup system of a small microphone array device, which includes the following modules: a non-linear multi-beamforming module configured to receive a multi-channel voice input signal from the small microphone array device, divide an area where the small microphone array device is located into a sound pickup area(s) and a shield area(s), subdivide the sound pickup area(s) and the shield area(s) respectively into a plurality of angles, perform a non-linear beamforming on beams in each angle to obtain a weight gain(s) corresponding to each frequency point data in the sound pickup area(s) and a weight gain(s) corresponding to each frequency point data in the shield area(s), and multiply each frequency point data respectively by a corresponding weight gain(s) to obtain a multi-beam data set(s);
a sound pickup area synthesis module configured to an area synthesis on the multi-beam data set by using an area synthesis algorithm, synthesize a plurality of beams corresponding to each frequency point data to obtain a final weight gain for each frequency point, and multiply each frequency point data by the corresponding final weight gain, to obtain a synthesized area beam signal;
a voice detection module configured to process the area beam signal by using a voice activation detection algorithm based on a neural network, to obtain a label for the voice signal or the noise signal;
a post-processing module configured to perform an energy gain detection and a spectrum feature detection on the multi-beam data set and the area beam signal, to obtain a label for the sound pickup area voice signal or the shield area voice signal, wherein the shield area voice signal includes a noise signal and a to-be-shielded signal; and
a sound pickup area voice enhancement module configured to enhance the sound pickup area voice signal, suppress the to-be-shielded signal, and not process the noise signals, according to the labels.

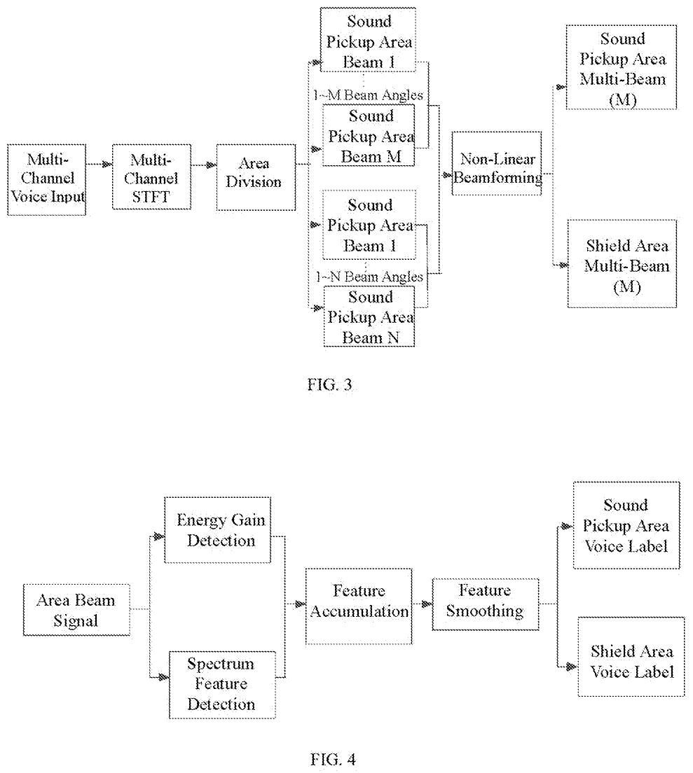

Referring to FIG. 3, Specifically, the multi-channel voice input signal is converted into a frequency domain signal from a time domain signal through the multi-channel voice-framing and a short-time Fourier transform (STFT).

Although the space is continuous, since the space cannot be subdivided infinitesimally due to a beam directivity, the space is only needed to be divided into a plurality of specified angles, that is, a plurality of discrete small areas, in the algorithm. For respective discrete small areas (pickup or shield areas), the non-linear beamforming is repeated multiple times.

The performing the non-linear beamforming on the beams in each angle to obtain the weight gain(s) corresponding to each frequency point data in the sound pickup area(s) and the weight gain(s) corresponding to each frequency point data in the shield area(s) is the same as those in the foregoing embodiment, and are not described herein again.

The non-linear beamforming algorithm described above is repeatedly performed for each angle, to obtain a preliminary area screening signal, i.e., the above multi-beam data set.

As shown in FIG. 4, the post-processing module includes an energy gain detection module that detects an energy gain by using a full band energy difference before and after each frame processing and a specific quantile gain value under a full band.

The post-processing module includes a spectrum feature detection module, and for the spectrum feature detection, a spectrum feature are detected by using spectrum difference values before and after each frame processing.

Preferably, the post-processing module includes a feature accumulation module and a feature smoothing module through which a jitter of values is eliminated.

In area sound pickup method and system of a small microphone array device according to the present disclose, for possible signals and interference sound sources, a non-linear beamformer and a post-filter based on feature statistics is used to enhance the ability to select sound sources in various directions in the space. Furthermore, the intelligent voice detection mechanism based on deep learning is added to further enhance the judgment accuracy for noise, voice and interference components, and to improve the robustness of the system. An area pickup effect in a general non-noisy scene may be achieved.

The above embodiments are merely illustrated preferred embodiments for fully explaining the present disclose, and the protection scope of the present disclose is not limited thereto. Equivalent substitutions or variations made by those skilled in the art on the basis of the present disclose are within the protection scope of the present disclose. The protection scope of the present disclose is subject to the claims.

What is claimed is:

1. An area pickup method for a small microphone array device, comprising the steps of:
S1. receiving a multi-channel voice input signal from the small microphone array device, dividing an area where the small microphone array device is located into a sound pickup area and a shield area, subdividing the sound pickup area and the shield area respectively into a plurality of angles, performing a non-linear beamforming on beams in each angle to obtain a weight gain corresponding to each frequency point data in the sound pickup area and a weight gain corresponding to each frequency point data in the shield area, and multiplying each frequency point data respectively by a corresponding weight gain to obtain a multi-beam data set;
S2. performing an area synthesis on the multi-beam data set by using an area synthesis algorithm, synthesizing a plurality of beams corresponding to each frequency point data to obtain a final weight gain for each frequency point, and multiplying each frequency point data by the corresponding final weight gain, to obtain a synthesized area beam signal;
S3. processing the area beam signal by using a voice activation detection algorithm based on a neural network, to obtain a label for the voice signal or the noise signal;
S4. performing an energy gain detection and a spectrum feature detection on the multi-beam data set and the area beam signal to obtain a label for a sound pickup area voice signal or a shield area voice signal, wherein the shield area voice signal includes a noise signal and a to-be-shielded signal; and
S5. according to the labels, enhancing the sound pickup area voice signal, suppressing the to-be-shielded signal, and not processing the noise signals.

2. The area pickup method for the small microphone array device according to claim 1, wherein,
the performing the non-linear beamforming on the beams in each angle to obtain the weight gain corresponding to each frequency point data in the sound pickup area and the weight gain corresponding to each frequency point data in the shield area comprises:
for a plurality of microphone arrays of a microphone device, a transfer function h(θ) for a signal in a specified azimuth angle θ to reach respective microphones is shown below:
$$h ( θ ) = {\frac{1}{\sqrt{M}} [ 1 , {e}^{- jkdsin ( θ )} , … , {e}^{- jMkdsin ( θ )} ]}^{T}$$
wherein k=2πƒ/c, ƒ represents a frequency, c represents a sound velocity, d represents a microphone pitch, and M represents the number of microphones;
an observed signal vector for each microphone at each frequency point is obtained as following:
$${x}_{m} ( k , θ ) = \text{?} ( k , θ ) S ( k , θ ) + {h}_{i} ( k , θ ) {S}_{i} ( k , θ ) + n ( k , θ )$$
$$\text{?} \text{indicates text missing or illegible when filed}$$
wherein S(k,θ) represents a signal component expected to be obtained, hₛ represents a transfer function of the signal component expected to be obtained; Sᵢ(k,θ) represents an interference signal component, hᵢ is a transfer function of the interference signal component; η(k,θ) represents a noise component; and 0≤m≤M−1;
an observed signal vector for all microphones at each frequency point is obtained as following:
X(k,θ)=[x₁(k,θ),x₂(k,θ), . . . ,x_{M}(k,θ)]^{T}
on the basis of the current beamforming output, an adaptive gain value g is further multiplied, and the result is expressed as:
Ŷ=gY, i.e. Ŷ=g·w^{H}X
wherein Y=w^{H}X, W represents a weight, H represents a transpose conjugate;
the weight gain for each frequency point data is expressed as:
$${g}^{*} = {arg min}_{g} E [ {\vert {w}^{H} {h}_{s} S - {gw}^{H} X \vert}^{2} ]$$
wherein E[·] represents a mathematical expectation, represents an expected actual signal, and the internal polynomial is expanded to obtain:
$${g}^{*} = {arg min}_{g} E [ \vert {w}^{H} {\vert Y \vert}^{2} ‐ g {\vert {w}^{H} {h}_{s} \vert}^{2} {\vert S \vert}^{2} \vert ] = {arg min}_{g} g - \frac{E [ {\vert {w}^{H} {h}_{s} \vert}^{2} {\vert S \vert}^{2} ]}{E [ {\vert S \vert}^{2} ]}$$
considering a minimization condition, it is omitted as following:
$${g}^{*} = \frac{E [ {\vert {w}^{H} {h}_{s} \vert}^{2} {\vert S \vert}^{2} ]}{E [ {\vert S \vert}^{2} ]} .$$

3. The area pickup method for the small microphone array device according to claim 1, wherein,
in step S4, an energy gain is detected by using a full band energy difference before and after each frame processing and a specific quantile gain value under a full band.

4. The area pickup method for the small microphone array device according to claim 1, wherein,
a spectrum feature is detected by using spectrum difference values before and after each frame processing.

5. The area pickup method for the small microphone array device according to claim 1, wherein,
in step S4, a jitter of values is eliminated by a feature accumulation and a feature smoothing.

6. The area pickup method for the small microphone array device according to claim 1, wherein,
the receiving the multi-channel voice input signal from the small microphone array device comprises:
the multi-channel voice input signal is converted into a frequency domain signal from a time domain signal through a multi-channel voice-framing and a short-time Fourier transform.

7. The area pickup method for the small microphone array device according to claim 1, wherein,
after obtaining the synthesized area beam signal, the area pickup method further comprises:
according to a probability density synthesis principle, obtaining the final weight gain of the synthesized area beam signal for each frequency point.

8. The area pickup method for the small microphone array device according to claim 1, wherein,
the processing the area beam signal by using the voice activation detection algorithm based on the neural network, to obtain the label for the voice signal or the noise signal comprises:
performing a convolution on the area beam signal in a time-frequency axis;
calculating a convolved output by using a PRelu activation function;
connecting a calculated output to a maximum pooling layer for pooling;
sending a pooled output to a normalization layer for a normalization process;
sending a normalized output to an LSTM layer for detection; and
sending a detected output to a DNN fully connected layer for classification, and outputting a final frame prediction result through a Sigmoid function, thereby obtaining the label for the voice signal or the noise signal.

9. The area pickup method for the small microphone array device according to claim 1, wherein,
the enhancing the sound pickup area voice signal, suppressing the to-be-shielded signal, and not processing the noise signals according to the labels comprises:
keeping amplitudes of the noise signals and an amplitude of a suppressed shielded signal at a similar level, and meanwhile enhancing the voice signal in the sound pickup area.

10. An area sound pickup system of a small microphone array device, comprising the following modules:
a non-linear multi-beamforming module configured to receive a multi-channel voice input signal from the small microphone array device, divide an area where the small microphone array device is located into a sound pickup area and a shield area, subdivide the sound pickup area and the shield area respectively into a plurality of angles, perform a non-linear beamforming on beams in each angle to obtain a weight gain corresponding to each frequency point data in the sound pickup area and a weight gain corresponding to each frequency point data in the shield area, and multiply each frequency point data respectively by a corresponding weight gain to obtain a multi-beam data set;
a sound pickup area synthesis module configured to an area synthesis on the multi-beam data set by using an area synthesis algorithm, synthesize a plurality of beams corresponding to each frequency point data to obtain a final weight gain for each frequency point, and multiply each frequency point data by the corresponding final weight gain, to obtain a synthesized area beam signal;
a voice detection module configured to process the area beam signal by using a voice activation detection algorithm based on a neural network to obtain a label for the voice signal or the noise signal;
a post-processing module configured to perform an energy gain detection and a spectrum feature detection on the multi-beam data set and the area beam signal to obtain a label for a sound pickup area voice signal or a shield area voice signal, wherein the shield area voice signal comprises a noise signal and a to-be-shielded signal; and
a sound pickup area voice enhancement module configured to enhance the sound pickup area voice signal, suppress the to-be-shielded signal, and not process the noise signals, according to the labels.

11. The area sound pickup system of the small microphone array device according to claim 10, wherein the performing the non-linear beamforming on the beams in each angle to obtain the weight gain corresponding to each frequency point data in the sound pickup area and the weight gain corresponding to each frequency point data in the shield area comprises:
for a plurality of microphone arrays of a microphone device, a transfer function h(θ) for a signal in a specified azimuth angle θ to reach respective microphones is shown below:
$$h ( θ ) = {\frac{1}{\sqrt{M}} [ 1 , {e}^{- jkdsin ( θ )} , … , {e}^{- jMkdsin ( θ )} ]}^{T}$$
wherein k=2πƒ/c, ƒ represents a frequency, c represents a sound velocity, d represents a microphone pitch, and M represents the number of microphones;
an observed signal vector for each microphone at each frequency point is obtained as following:
$${x}_{m} ( k , θ ) = \text{?} ( k , θ ) S ( k , θ ) + {h}_{i} ( k , θ ) {S}_{i} ( k , θ ) + n ( k , θ )$$
$$\text{?} \text{indicates text missing or illegible when filed}$$
wherein S(k, θ) represents a signal component expected to be obtained, hₛ represents a transfer function of the signal component expected to be obtained; Sᵢ(k, θ) represents an interference signal component, hᵢ is a transfer function of the interference signal component; η(k,θ) represents a noise component; and 0≤m≤M−1;
an observed signal vector for all microphones at each frequency point is obtained as following:
X(k,θ)=[x₁(k,θ),x₂(k,θ), . . . ,x_{M}(k,θ)]^{T}
on the basis of the current beamforming output, an adaptive gain value g is further multiplied, and the result is expressed as:
Ŷ=gY, i.e. Ŷ=g·w^{H}X
wherein Y=w^{H}X, w, represents a weight, H represents a transpose conjugate;
the weight gain for each frequency point data is expressed as:
$${g}^{*} = {arg min}_{g} E [ {\vert {w}^{H} {h}_{s} S - {gw}^{H} X \vert}^{2} ]$$
wherein E[·] represents a mathematical expectation, represents an expected actual signal, and the internal polynomial is expanded to obtain:
$${g}^{*} = {arg min}_{g} E [ \vert {w}^{H} {\vert Y \vert}^{2} ‐ g {\vert {w}^{H} {h}_{s} \vert}^{2} {\vert S \vert}^{2} \vert ] = {arg min}_{g} g - \frac{E [ {\vert {w}^{H} {h}_{s} \vert}^{2} {\vert S \vert}^{2} ]}{E [ {\vert S \vert}^{2} ]}$$
considering a minimization condition, it is omitted as following:
$${g}^{*} = \frac{E [ {\vert {w}^{H} {h}_{s} \vert}^{2} {\vert S \vert}^{2} ]}{E [ {\vert S \vert}^{2} ]} .$$

12. The area sound pickup system of the small microphone array device according to claim 10, wherein the post-processing module comprises an energy gain detection module that detects an energy gain by using a full band energy difference before and after each frame processing and a specific quantile gain value under a full band.

13. The area sound pickup system of the small microphone array device according to claim 10, wherein the post-processing module comprises a spectrum feature detection module, and the spectrum feature detection detects a spectrum feature are detected by using spectrum difference values before and after each frame processing.

14. The area sound pickup system of the small microphone array device according to claim 10, wherein the post-processing module comprises a feature accumulation module and a feature smoothing module through which a jitter of values is eliminated.

15. The area sound pickup system of the small microphone array device according to claim 10, wherein the non-linear multi-beamforming module is further configured to convert the multi-channel voice input signal into a frequency domain signal from a time domain signal through a multi-channel voice-framing and a short-time Fourier transform.

16. The area sound pickup system of the small microphone array device according to claim 10, wherein the sound pickup area synthesis module is further configured to obtain the final weight gain of the synthesized area beam signal for each frequency point, according to a probability density synthesis principle.

17. The area sound pickup system of the small microphone array device according to claim 10, wherein the voice detection module is further configured to:
perform a convolution on the area beam signal in a time-frequency axis;
calculate a convolved output by using a PRelu activation function;
connect a calculated output to a maximum pooling layer for pooling;
send a pooled output to a normalization layer for a normalization process;
send a normalized output to an LSTM layer for detection; and
send a detected output to a DNN fully connected layer for classification, and output a final frame prediction result through a Sigmoid function, thereby obtaining the label for the voice signal or the noise signal label.

18. The area sound pickup system of the small microphone array device according to claim 10, wherein the sound pickup area voice enhancement module is configured to keep amplitudes of the noise signals and an amplitude of a suppressed shielded signal at a similar level, and meanwhile enhance the voice signal in the sound pickup area.

19. A small microphone array device comprising microphone devices and a processor, wherein the processor is configured to:
S1. receiving a multi-channel voice input signal from the small microphone array device, dividing an area where the small microphone array device is located into a sound pickup area and a shield area, subdividing the sound pickup area and the shield area respectively into a plurality of angles, performing a non-linear beamforming on beams in each angle, to obtain a weight gain corresponding to each frequency point data in the sound pickup area and a weight gain corresponding to each frequency point data in the shield area, and multiplying each frequency point data respectively by a corresponding weight gain to obtain a multi-beam data set;
S2. performing an area synthesis on the multi-beam data set by using an area synthesis algorithm, synthesizing a plurality of beams corresponding to each frequency point data to obtain a final weight gain for each frequency point, and multiplying each frequency point data by the corresponding final weight gain, to obtain a synthesized area beam signal;
S3. processing the area beam signal by using a voice activation detection algorithm based on a neural network, to obtain a label for the voice signal or the noise signal;
S4. performing an energy gain detection and a spectrum feature detection on the multi-beam data set and the area beam signal to obtain a label for a sound pickup area voice signal or a shield area voice signal, wherein the shield area voice signal comprises a noise signal and a to-be-shielded signal; and
S5. according to the labels, enhancing the sound pickup area voice signal, suppressing the to-be-shielded signal, and not processing the noise signals.

20. The small microphone array device according to claim 19, wherein in step S1, the processor is further configured for:
for a plurality of microphone arrays of the microphone device, a transfer function h(θ) for a signal in a specified azimuth angle θ to reach respective microphones is shown below:
$$h ( θ ) = {\frac{1}{\sqrt{M}} [ 1 , {e}^{- jkdsin ( θ )} , … , {e}^{- jMkdsin ( θ )} ]}^{T}$$
wherein k=2πƒ/c, ƒ represents a frequency, c represents a sound velocity, d represents a microphone pitch, and M represents the number of microphones;
an observed signal vector for each microphone at each frequency point is obtained as following:
$${x}_{m} ( k , θ ) = \text{?} ( k , θ ) S ( k , θ ) + {h}_{i} ( k , θ ) {S}_{i} ( k , θ ) + n ( k , θ )$$
$$\text{?} \text{indicates text missing or illegible when filed}$$
wherein S(k,θ) represents a signal component expected to be obtained, hₛ represents a transfer function of the signal component expected to be obtained; Sᵢ(k, θ) represents an interference signal component, hᵢ is a transfer function of the interference signal component; η(k,θ) represents a noise component; and 0≤m≤M−1;
an observed signal vector for all microphones at each frequency point is obtained as following:
X(k,θ)=[x₁(k,θ),x₂(k,θ), . . . ,x_{M}(k,θ)]^{T}
on the basis of the current beamforming output, an adaptive gain value g is further multiplied, and the result is expressed as:
Ŷ=gY, i.e. Ŷ=g·w^{H}X
wherein Y=w^{H}X, w represents a weight, H represents a transpose conjugate;
the weight gain for each frequency point data is expressed as:
$${g}^{*} = {arg min}_{g} E [ {\vert {w}^{H} {h}_{s} S - {gw}^{H} X \vert}^{2} ]$$
wherein E[·] represents a mathematical expectation, S represents an expected actual signal, and the internal polynomial is expanded to obtain:
$${g}^{*} = {arg min}_{g} E [ \vert {w}^{H} {\vert Y \vert}^{2} ‐ g {\vert {w}^{H} {h}_{s} \vert}^{2} {\vert S \vert}^{2} \vert ] = {arg min}_{g} g - \frac{E [ {\vert {w}^{H} {h}_{s} \vert}^{2} {\vert S \vert}^{2} ]}{E [ {\vert S \vert}^{2} ]}$$
considering a minimization condition, it is omitted as following:
$${g}^{*} = \frac{E [ {\vert {w}^{H} {h}_{s} \vert}^{2} {\vert S \vert}^{2} ]}{E [ {\vert S \vert}^{2} ]} .$$
